(19) United States
(12) Patent Application Publication
(10) Pub. No.: US 2012/0207959 A1
(43) Pub. Date: Aug. 16, 2012

(54) PET PAW MAGIC MAT

(76) Inventor: GINA M. PROTOCOLLO, VALLEY CENTER, CA (US)

(21) Appl. No.: 13/371,429

(22) Filed: Feb. 11, 2012

Related U.S. Application Data
(60) Provisional application No. 61/463,299, filed on Feb. 14, 2011.

(51) Int. Cl. C09J 7/02; B32B 3/10; B32B 27/40; B32B 33/00; B32B 25/00

(52) U.S. Cl. 428/40.1; 428/201; 428/203; 428/172

(57) ABSTRACT

The Pet Paw Magic Mat is used to collect dirt, food and any foreign object introduced by pets. The double sticky side layer and one-side sticky layer will enable pet owners to collect any object from, for example, the paws of their pets with minimal effort. The soiled outer layer can be removed by simply peeling off the outer layer.

This application claims the benefit of U.S. Provisional Application No. 61/463299, filed Feb. 14, 2011, the entire disclosure of which is incorporated herein.

### FIELD OF THE INVENTION

The present invention relates to a pet mat having dual functionality, where it can be used for litter boxes, for entrance to homes, recreational vehicles (RVs), and the like. In particular, the invention is a multi-layered mat with a peelable, double-sided sticky sheet, and a printed logo sheet provided with a non-skid backing mat.

### BACKGROUND

Pets are part of everyday life in the United States, and having pets has its disadvantages. In addition, pets typically cannot wipe their feet upon re-entering their homes and, therefore, they introduce dirt when entering the home. Thus, reentry into the homes causes even more problems in rainy seasons, particularly where the pet may introduce mud and/or other debris that has adhered to its feet.

In addition to problems associated with pets, entrance to recreational vehicles (RVs) create its own problems. Due to the surrounding areas where RVs may travel, such as deserts, mud-saturated areas, and the like, many RV owners have to deal with dirt, mud and other debris also introduced by their pets that accompany them on their outing trips.

Accordingly, a need exists for minimizing the transference of dirt or other undesirable materials stemming from a pet re-entering the home or RVs from outside.

### SUMMARY OF THE INVENTION

The present invention provides an inexpensive, multilayer mat serving multiple purposes for all pet owners. In an embodiment, the present invention comprises a first non-skid layer, a second layer having a printed image, a means for attaching said second layer to said first layer, and a third layer having a double-sided sticky layer, wherein said double-sided sticky layer is a removable layer.

In another embodiment, the present invention comprises a first non-skid layer that is selected from the group consisting of rubber, urethane, recycled plastic, or other synthetic material.

In still another embodiment, the present invention comprises a second layer that comprises a vinyl layer with a printed logo on its top side.

In yet another embodiment, the present invention comprises a second and third layers that are transparent, such that the printed logo is visible through the layers.

In a further embodiment, the present invention comprises a printed image on a second layer that can be a custom-made image.

In another embodiment, the present invention comprises an indentation on at least one of the corners of the top side of the third layer.

In still another embodiment, the present invention further comprises a non-sticky indentation on the top side of the third layer.

In another embodiment of the present invention, the vinyl second layer comprises a sticky side on its bottom side.

In yet another embodiment of the present invention, the third layer comprises one or more double-sided sticky sheets.

In another embodiment of the present invention, the double-sided sticky sheets comprise 1 to 10 sheets.

In still another embodiment of the present invention, the double-sided sticky sheets are removable.

In yet another embodiment of the present invention, the removable sheets are window double-sided adhesive.

In another embodiment, the present invention further comprises a method of making a pet mat comprising the steps of: providing a non-skid layer; a second layer with an image on the top side of the second layer; a third double-sided sticky layer with a non-sticky indentation on at least one corner of the layer.

In another embodiment of the present invention, the second layer is connected to the first layer via the sticky underside of the second layer.

In still another embodiment of the present invention, the pet mat measures about 17 by 20 inches.

In yet another embodiment of the present invention, the length and width dimension of the pet mat can be customized to fit into a predefined area. For example, the pet mat can be made to accommodate smaller pets and/or smaller areas. Further, the pet mat can be made to accommodate larger pets and/or larger areas.

In a further embodiment, the present invention further comprises a first non-skid layer having a printed image, and a double-sided sticky second layer having a non-sticky indentation.

In still another embodiment of the present invention, the non-sticky indentation is on any corner of the second layer.

In another embodiment of the present invention, the first layer is tufted loop material bound edges with rubber bottom rectangular corners.

In yet another embodiment of the present invention, the first layer is needle punch face with urethane comfort mat material.

In an embodiment of the present invention, the first layer is needle punch face with a non-slip latex/rubber bottom.

In a further embodiment of the present invention, the printed image can be custom-made.

In still another embodiment of the present invention, the removable sheet(s) comprise 1 or more sheets.

In an embodiment of the present invention, the removable sheets comprise 1, 2, 3, 4, 5, 6, 7, 8, 9 or 10 sheets.

In yet another embodiment of the present invention, the removable sheets are window double-sided adhesive.

### BRIEF DESCRIPTION OF THE FIGURES

FIGS. 1 to 3 depict an embodiment of the mat of the present invention, showing the first non-skid layer, the second vinyl logo layer, and the third double-sided sticky layer, respectively.

FIG. 4 is an embodiment of the invention, wherein a non-sticky indentation on the corner of the third layer provides a means of peeling the outer layer of the mat.

FIG. 5 depicts a side view of an embodiment of the present invention.

FIGS. 6 to 7 depict another embodiment of the present invention, wherein the first layer is a non-skid layer with the printed logo and the second layer is a double-sided sticky layer.

### DETAILED DESCRIPTION OF THE INVENTION

The present invention, called Pet Paw Magic Mat with a custom printed logo, solves the aforementioned problem. The Pet Paw Magic Mat is used to collect dirt, pet food, litter, and the like by means of one or more sticky layers on an outer layer of the present invention.

In another aspect of the present invention, the collection of dirt, pet food, debris, and the like can be typically accomplished with minimal or no effort by the pet or the pet owner. The foreign objects simply adhere to the Pet Paw Magic Mat by the action of the pet stepping on the outer sticky layer of the mat, whereby the foreign material adheres to the sticky mat.

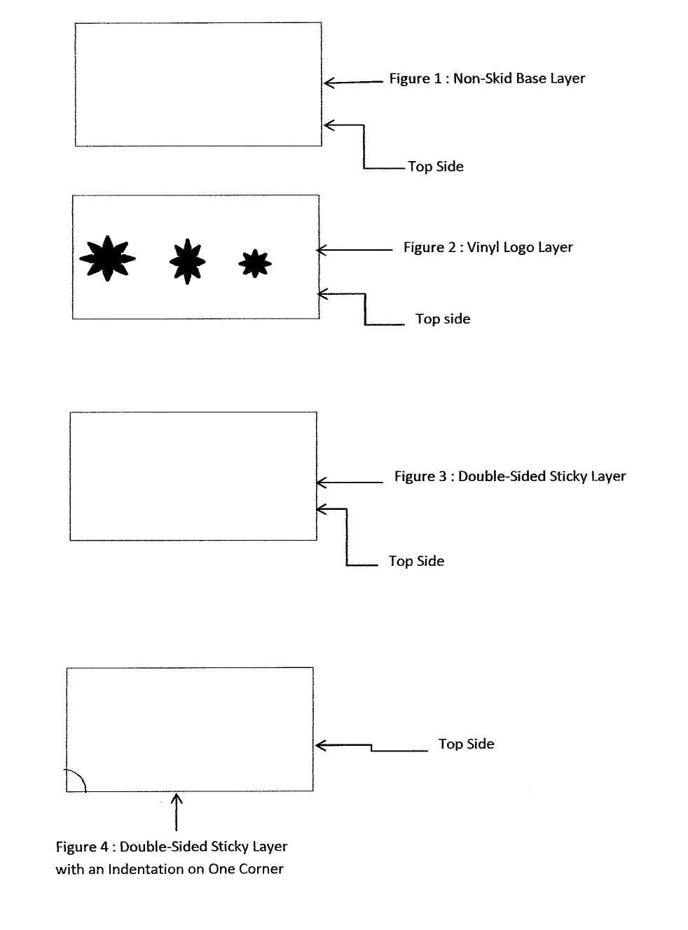

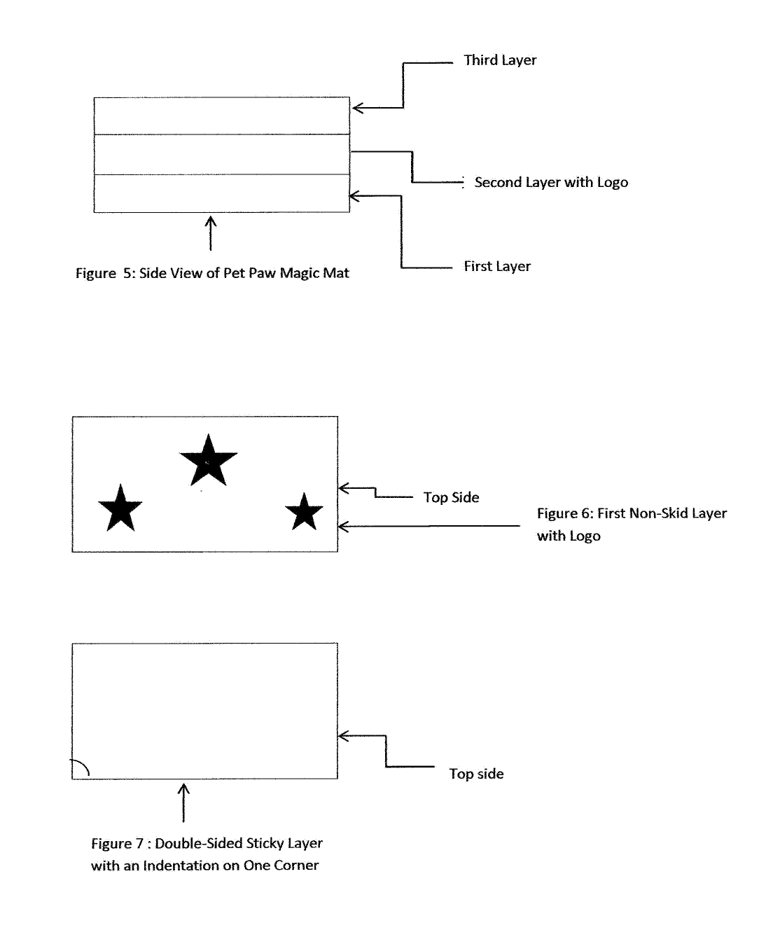

An exemplary manner and process of making the invention is shown in FIGS. 1 to 4. Each layer has a top side and bottom side. The first layer comprises a non-skid material. The second layer comprises a clear vinyl sheet with a printed logo, and the third layer comprises one or more clear double-sided sheets.

In one embodiment, the first layer comprises a non-skid material, the second layer comprises a vinyl material with a sticky side on the bottom side of said second layer. The sticky bottom side of the second layer is connected to the top side of the first layer. The second layer incorporates a logo printed on its top side. Further, the third layer comprises a double-sided sticky layer that adheres to the top side of the second layer. The third layer further comprises one or more sheets of removable double-sided sticky sheets. As the third layer can no longer collect dirt due top repeated use of the pet traversing the top sticky side, one of the individual sheets from the top side of the third layer may be removed to yield a fresh sheet underlying the removed sheet. In one embodiment, the outer sheet of the third layer may then be removed in a peeling motion by grasping the non-stick indentation on its corner and removing the outer sheet to expose the underlying sheet.

The double-sided sticky sheet is also referred to as a removable sheet. The double-sided sticky sheet is also referred to as a clear removable sheet.

In an embodiment of the present invention, the first layer comprises rubber, urethane, recycled plastic, or some other synthetic material.

In another embodiment of the invention, the vinyl second layer comprises a customized logo of choice printed on its top side. The second layer is, for example, vinyl, such that the printed logo can be visible through the double-sided sticky clear sheets. The logo is printed onto the second layer by processes known in the state in the art. Exemplary printing methods include silk screening, stenciling, and the like. The printed logo may be a picture, trademark, service mark or any other logo of choice.

In yet another embodiment, the third layer comprises window double-sided adhesive material.

In yet another embodiment of the present invention, the third layer comprises one to ten removable clear sheets. The number of removable sheets may exceed ten, but visibility of the underlying logo may be impacted by more than twenty sheets.

Pet Paw Magic Mat is to be used in connection with litter boxes, feeding areas of pets, pet doors, and any other entryway such as entry to RVs.

In one embodiment, the mat of the present invention is used in the following stepwise manner, where there is more than one clear double-sided sticky sheet:

Step 1. Place the mat with the clear double-sided sticky side up in front of the pet door, under the litter box, around the pet food tray, entry to the RV, or in front of any relevant entryway. Any dirt introduced by the pet from the feeding area, litter box or through the pet door will adhere to the outer sticky side of the third layer.

Step 2: After the third layer is full of dirt or has reduced capacity to adhere debris due to repeated use, simply use the non-sticky indentation of the third layer to peel off the dirty layer. A fresh underlying layer is then exposed and ready for future use.

In yet another embodiment, the mat of the present invention is used in the following stepwise manner, where there is one clear double-sided sticky sheet:
Step 1. Place the mat with the clear double-sided sticky side up in front of the pet door, under the litter box, around the pet food tray, entry to the RV, or in front of any relevant entryway. Any dirt introduced by the pet from the feeding area, litter box or through the pet door will adhere to the outer sticky side of the third layer.
Step 2: After the third layer is full of dirt, simply use the non-sticky indentation of the third layer to peel off the dirty layer, remove said layer and replace it with a fresh layer for future use.

In another embodiment of the present invention, the pet mat comprises a first non-skid layer with a logo printed on its top side, and a second double-sided, sticky, clear layer.

In one embodiment, the first non-skid layer comprises tufted loop material bound edges with rubber bottom rectangular corners.

In another embodiment, the first non-skid layer comprises needle punch face with urethane comfort mat material.

In yet another embodiment, the first non-skid layer comprises needle punch face with non slip latex/rubber bottom.

In another embodiment, the logo is printed on the first non-skid layer by means of dye sublimation process. Said printed logo is a picture, trademark, service mark or any other logo of choice.

The invention has been described by the preceding paragraphs, but is not intended in any way to be limited by the aforementioned description. One of ordinary skill in the art will understand that similar materials, processes and uses are equivalent and embraced by the foregoing description.

1. A pet mat comprising:
i) a first non-skid layer;
ii) a second layer having a printed image;
iii) a means for attaching said second layer to said first layer; and
iv) a third layer having a double-sided sticky layer;
wherein said double-sided sticky layer is a removable layer.

2. The pet mat according to claim 1, wherein said first non-skid layer is selected from the group consisting of rubber, urethane, recycled plastic, or other synthetic material.

3. The pet mat according to claim 1, wherein said second layer comprises a vinyl layer with a printed logo on its top side.

4. The pet mat according to claim 1, wherein said second and third layers are transparent, such that said printed logo is visible through said second and third layers.

5. The pet mat according to claim 1, wherein said printed image can be custom made.

6. The pet mat according to claim 1, wherein said top side of said third layer has an indentation on at least one of its corners.

7. The pet mat according to claim 1, wherein said vinyl second layer is sticky on its bottom side.

8. The pet mat according to claim 1, wherein said third layer comprises one or more double-sided sticky sheets.

9. A pet mat comprising:
i) a first non-skid layer having a printed image; and
ii) a double-sided sticky second layer having a non-sticky indentation, wherein said second layer further comprises one or more removable sheets.

10. The pet mat according to claim 9 wherein said non-sticky indentation is on any corner of said second layer.

11. The pet mat according to claim 9, wherein said first non-skid layer is tufted loop material having bound edges with rubber bottom rectangular corners.

12. The pat mat according to claim 9, wherein said first non-skid layer is selected from needle punch face with urethane comfort mat material or non-slip latex/rubber bottom.

13. The pet mat according to claim 9, wherein said printed image can be custom made.

14. The pet mat according to claim 9, wherein said removable sheets comprise 1 or more sheets.

15. The pet mat according to claim 9, wherein each of said removable sheets is window double-sided adhesive.
